(19) United States
(12) Patent Application Publication
(10) Pub. No.: US 2010/0115400 A1
(43) Pub. Date: May 6, 2010

(54) INFORMATION PROCESSING APPARATUS AND INFORMATION PROCESSING METHOD

(75) Inventor: Kazunari Yamanakajima, Kawasaki-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/575,059

(22) Filed: Oct. 7, 2009

(30) Foreign Application Priority Data
Nov. 5, 2008 (JP) 2008-284731

(51) Int. Cl. G06F 17/00

(52) U.S. Cl. 715/243

(57) ABSTRACT

An information processing technology is provided that realizes an automatic layout system capable of applying a single template to different format types. The present invention relates to an information processing method performed in an information processing apparatus that creates a link between containers placed on a template, and performs layout processing corresponding to that link in response to input of data into the containers, and the method includes a step of determining an area where containers can be placed in the template according to the paper size set for the template, a step of creating a link associating a boundary line of the above-mentioned area with the containers, and a step of changing, in the case where the paper size set for the template has been changed, the position and the size of that container corresponding to the link created in the above-described creation step.

### BACKGROUND OF THE INVENTION

1. Field of the Invention

The present invention relates to an information processing technology for controlling the layout of data on a document.

2. Description of the Related Art

With the spread of the Internet into ordinary homes in addition to the shortened life cycle of products due to an increase in product types, customers are increasingly demanding the customization of services in recent years. For this reason, approaches for customizing services, such as CRM (Customer Relationship Management) and One-to-One marketing, have started garnering attention. The reason is that employing such approaches will increase the level of customer satisfaction, thereby making it possible to acquire or retain customers.

“One-to-One marketing” is one type of database marketing, and offers suggestions that suit customer's needs by compiling a database of individual attribute information such as the age, sex, hobbies, preferences and buying history of customers, and analyzing the content thereof.

Meanwhile, with the recent advance of desktop publishing technology and the spread of digital printing devices, in addition to such an increase in the demand for the customization of services, variable print systems in which documents are output after being customized on a customer-by-customer basis is being developed. Furthermore, the development of variable print systems is also accompanied by the development of automatic layout systems for optimally laying out data in different amounts for each customer.

In this respect, conventional automatic layout systems lay out a container with a predetermined size on a document, and associate a database with the container, thereby realizing automatic layout of data on the document. However, if the size of a container is fixed, data overlap, data omissions or the like will occur when the amount of data inserted into the container is larger than the size of the container. Conversely, when the amount of data inserted into a container is smaller than the size of the container, a gap will be created.

For this reason, current automatic layout systems are configured such that the size of a container can be variably set on a defined template. As a result, it is possible to automatically change the size of a container according to the amount of data that is inserted.

Furthermore, if the data that is inserted is text, it is also possible to automatically reduce the font size of the text when an amount of data that cannot fit within a fixed container size has been inserted, and perform control such that the entirety of the text will be displayed within the container.

However, as described above, in the case of a configuration in which the container size is automatically increased, it is conceivable that the container may overlap another container located on the same document. In the case of a configuration in which the font size is automatically reduced, there may be the problem that the font size is too small if the amount of text inserted is greater than a predetermined amount.

Therefore, there has been proposed an automatic layout system that performs control such that when the size of a predetermined container has been changed, the size of another container adjacent to that container is also automatically changed (see e.g., Japanese Patent Laid-Open No. 2000-48216).

There has been also proposed a configuration in which a mechanism called “flow area” is introduced, and a plurality of similar data pieces are placed with an arbitrary spacing in a specific area within a page by causing a sub-template having a defined basic shape to flow inside the flow area (see e.g., Japanese Patent Laid-Open No. 2005-216182).

Furthermore, there have been also provided a configuration in which a plurality of flow areas are placed on a single page (see e.g., Japanese Patent Laid-Open No. 2006-221582 and Japanese Patent Laid-Open No. 2005-216182), and a configuration in which a plurality of flow areas are linked with each other so that their sizes can be adjusted relative to each other (Japanese Patent Laid-Open No. 2006-74226).

Here, all of the above-described automatic layout systems are configured such that a template created is dependent on the size of paper that is output, especially the format type (A4 format, B5 format, US Letter Size, and so on) thereof. Therefore, in the case where the format type of the paper size that is output has been changed, it is necessary to re-edit the template. That is, in the case of the above-described automatic layout systems, it was necessary to create a template for each format type in advance.

However, creating templates respectively corresponding to all format types in advance leads to an increase in the workload on the user, and makes it difficult to manage a template that is created.

### SUMMARY OF THE INVENTION

The present invention was made in view of the foregoing problems.

An information processing apparatus according to the present invention has the following configuration:

An information processing apparatus that creates a link associating partial areas placed on a template, and performs layout processing corresponding to a created link in response to input of data into the partial areas, and the apparatus includes:

a determination unit configured to determine, based on a paper size set for the template, an area where the partial areas can be placed in the template for each page constituting the template;

a creation unit configured to create a link associating a boundary line defining an outer edge of the area with the partial areas; and

a relocation unit configured to change, in the case where the paper size set for the template has been changed and the area has been changed, a position and a size of the partial areas corresponding to the link created by the creation unit.

According to the present invention, it is possible to provide an automatic layout system capable of applying a single template to different format types.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1A is a block diagram showing a configuration example of an automatic layout system 100.

FIG. 1B is a block diagram showing the configuration of a host computer (an information processing apparatus) 101 shown in FIG. 1A in further detail.

FIG. 2 is a diagram showing another configuration example of the automatic layout system.

FIG. 3 is a diagram showing an example of a window displayed in a display device 144 by executing a user interface 103.

FIG. 4 is a diagram showing the state of the sides of containers.

FIGS. 5A to 5C are diagrams for illustrating a link setting method.

FIG. 6 is a flowchart illustrating the flow of automatic layout processing.

FIG. 7 is a flowchart illustrating the details of layout calculation processing (step S603).

FIGS. 8A to 8C are diagrams showing an example of the operation of containers located on a work area 306 when layout calculation processing is performed.

FIG. 9 shows an outline of automatic layout processing for multiple records.

FIG. 10A is a diagram showing an example of a template that includes a page container and page links.

FIG. 10B is an enlarged view of the upper right portion of FIG. 10A.

FIG. 11A is a diagram showing an example of a template after changing the paper size set for the template shown in FIG. 10A and relocating containers following such a change.

FIG. 11B is a diagram showing an example of a template after changing the paper size set for the template shown in FIG. 10A and relocating containers following such a change.

FIG. 12 is a flowchart illustrating the flow of processing performed when relocating containers in a template.

FIG. 13 is a diagram showing an example of a document created by performing automatic layout processing for a template for which a paper size or a margin size has been changed during layout-editing processing.

FIG. 14 is a flowchart illustrating the flow of processing performed when a paper size set for a template has been changed after performing automatic layout processing and inserting data in View mode.

FIG. 15 is a diagram illustrating a group setting relating to the format type and the size of paper.

FIG. 16 is a diagram showing an example of a settings dialog for inputting settings relating to enlargement or reduction processing.

FIG. 17 is a diagram showing a template for which automatic Link processing has been performed in layout-editing processing.

FIG. 18 is a diagram showing an example of a settings dialog relating to automatic Link processing.

FIG. 19 is a flowchart illustrating the flow of automatic Link processing.

FIG. 20 is a diagram for illustrating page link automatic deletion processing.

### DESCRIPTION OF THE EMBODIMENTS

Embodiments of the present invention will now be described in detail in accordance with the accompanying drawings.

### First Embodiment

### 1. Configuration Example of Automatic Layout System

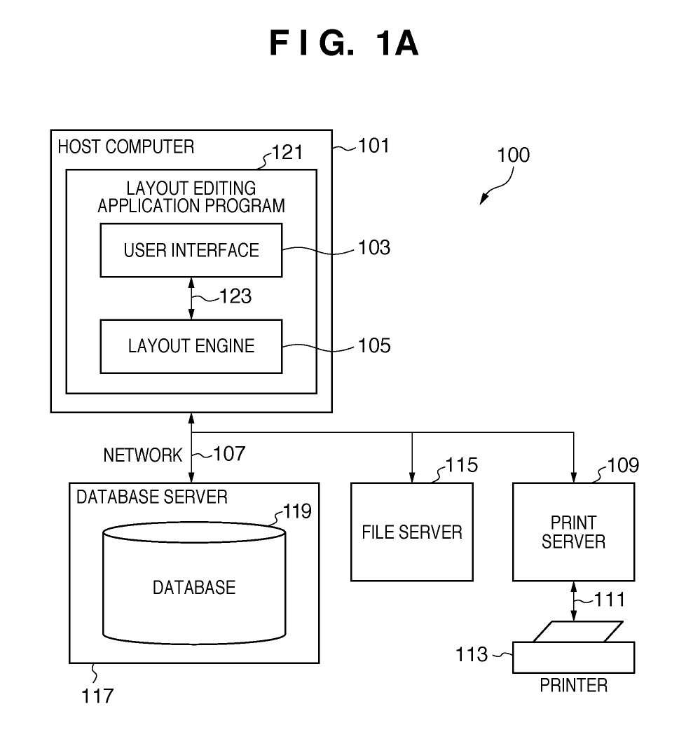

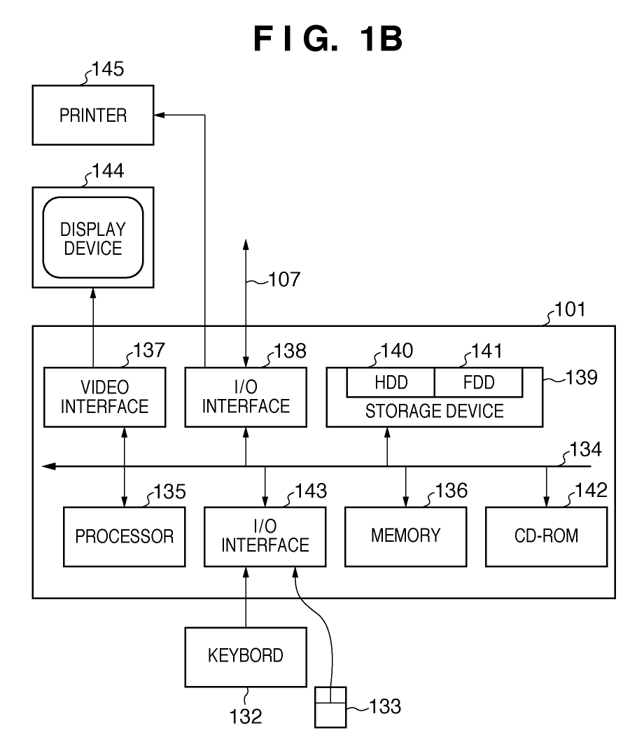

A configuration example of an automatic layout system including a host computer (an information processing apparatus) according to one embodiment of the present invention will be described with reference to FIGS. 1A and 1B.

FIG. 1A is a block diagram showing a configuration example of an automatic layout system 100. FIG. 1B is a block diagram showing the configuration of a host computer (an information processing apparatus) 101 shown in FIG. 1A in further detail.

1.1 Overall Configuration

An automatic layout system 100 includes a host computer 101 (an information processing apparatus configured from a general-purpose computer module). With the automatic layout system 100, “layout-editing processing”, “automatic layout processing” and the like described below are realized by the host computer 101 executing a layout editing application program 121.

The layout editing application program 121 includes two software components.

The first component is a layout engine 105 that inserts data into each container, and calculates a layout of the inserted data in a template, under a predetermined control condition (i.e., performs “automatic layout processing”). Through this layout calculation (automatic layout processing), a document is created.

The second component is a user interface 103 that creates a template by performing “layout-editing processing”. The user interface 103 also associates each container with data inserted into that container in the created template.

The user interface 103 and the layout engine 105 communicate with each other via a communication channel 123.

Data used for creating a document is stored in a database 119 on a database server 117 configured from another computer running a database application. The host computer 101 reads the data stored in the database 119 by communicating with the database server 117 via a network 107.

A template that is created by the layout editing application program 121 performing the layout-editing processing is saved in a file server 115.

Furthermore, a document that is created by the layout editing application program 121 performing the automatic layout processing is saved in a local file system of the host computer 101, or in the file server 115. Alternatively, such a document is directly printed out via a printer 113.

A print server 109 is a computer that provides the printer 113, which is not directly connected to the network 107, with network functionality. The print server 109 and the printer 113 are connected to each other via a commonly used communication channel 111.

1.2 Configuration of Host Computer

Next, the details of the configuration of the host computer 101 will be described. As shown in FIG. 1B, an input device including a keyboard 132 and a pointing device such as a mouse 133, as well as an output device including a display device 144, a local printer 145 and so on are connected to the host computer 101.

An input/output interface 138 connects the host computer 101 to another computer device via the network 107. The network 107 includes, for example, a local area network (LAN) and a wide area network (WAN).

The host computer 101 includes at least one processor 135, a memory 136, a video interface 137, and an input/output (I/O) interface 143.

The memory 136 is configured, for example, of a semiconductor random access memory (RAM) or read-only memory (ROM). The I/O interface 143 is an interface for connecting the keyboard 132, the mouse 133, and the like.

A storage device 139 includes a hard disk drive 140, a floppy disk drive 141 and so on. Although not shown in FIG. 1B, a magnetic tape drive, or the like may be used as the storage device.

A CD-ROM drive 142 is provided as a non-volatile data source. The host computer 101 uses an OS such as LINUX or Microsoft Windows (registered trademark) to operate the components 135 to 143 via an interconnection bus 134.

The layout editing application program 121 is resident in the hard disk drive 140, and is executed by being read by the processor 135. During execution, the layout editing application program 121 is temporarily stored in the memory 136 along with data fetched from the network 107.

Note that the layout editing application program 121 may not need to be resident in the hard disk drive 140. For example, the layout editing application program 121 may be configured such that it is stored in an encoded state on a CD-ROM or a floppy disk, and read via the CD-ROM drive 142 or the floppy disk drive 141. Alternatively, the layout editing application program 121 may also be configured such that it is read via the network 107.

Furthermore, the layout editing application program 121 may be configured such that it is read from various computer-readable media. Examples of the computer-readable media include a magnetic tape, a ROM, an integrated circuit, a magneto-optical disk and a PCMCIA card. Alternatively, the layout editing application program 121 may also be configured such that it is read by means of wireless or infrared communication or e-mail communication, or via the Internet, an intranet or the like.

2. Configuration Example of Another Automatic Layout System

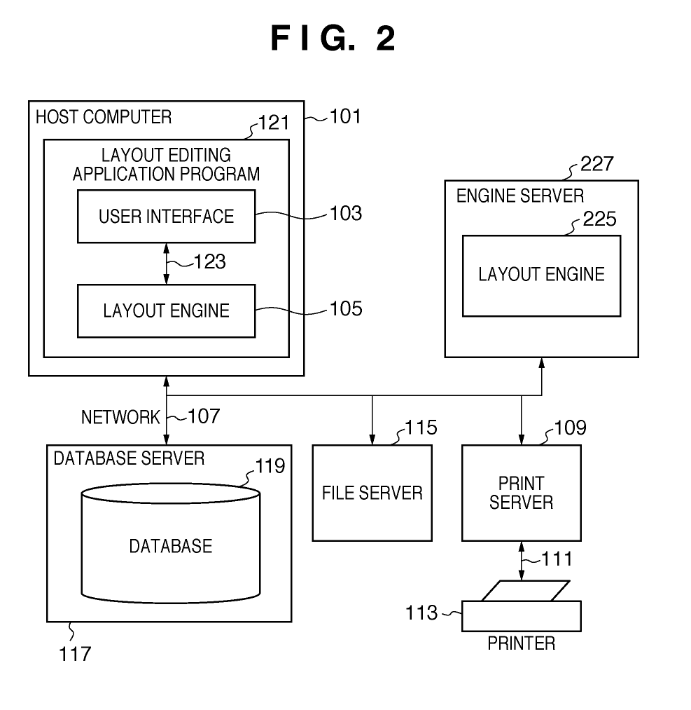

FIG. 2 is a diagram showing another configuration example of the automatic layout system. This configuration is similar to that shown in FIG. 1A, but is different in that an engine server 227 is added. A layout engine 225 stored in the engine server 227 is a discrete version of the layout engine 105. As the engine server 227, any commonly used computer can be used. In order to create a document, the layout engine 225 combines the template saved in the file server 115 with the data saved in the database 119. Such an operation is requested via the user interface 103.

3. Outline of Layout Editing Application Program

Next, an outline of various functions realized by performing the layout editing application program 121 will be described.

3.1 User interface

First, a function realized by the user interface 103 included in the layout editing application program 121 will be described.

(1) Description of Window

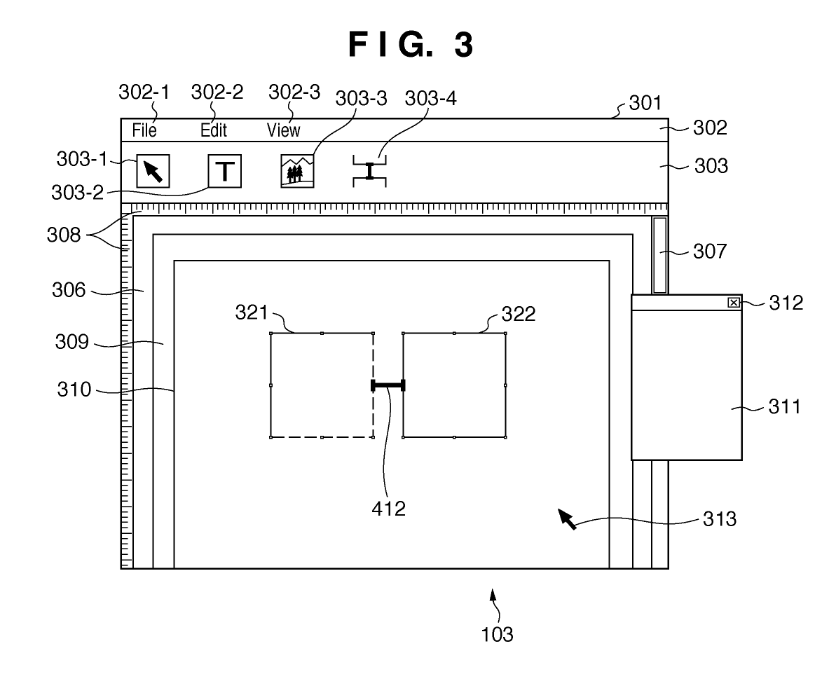

FIG. 3 is a diagram showing an example of a window displayed in the display device 144 by execution of the user interface 103.

A menu bar 302 and a tool bar 303 are displayed in a window 301. In addition, a work area 306, the details of which will be described later, that operates in accordance with an operation performed on the mouse 133, as well as an optional palette 311 and a pointer 313 that moves in correspondence with the operation of the mouse 133 are displayed.

The menu bar 302 includes menu items including a plurality of menu options. The menu items include an item 302-1 for selecting File mode, an item 302-2 for selecting Edit mode, and an item 302-3 for selecting View mode.

The item 302-1 is an item for giving template management instructions, including, for example, the calling of a template stored in the file server 115, and the saving of a created template.

The item 302-2 is an item for performing layout-editing processing for creating a template on the work area 306, or editing a created template.

The item 302-3 is an item for performing automatic layout processing for inserting data into a created template and creating a document.

The tool bar 303 includes the following tool buttons (303-1 to 303-4) that can be hidden or displayed depending on the mode.

1) Selection tool button (303-1): Used when giving an instruction to select, move, change the size of, resize, or lock/unlock the sides of a container.

2) Text container tool button (303-2): Used when creating a container into which fixed text data or variable text data is inserted.

3) Image container tool button (303-3): Used when creating a container into which fixed image data or variable image data is inserted.

4) Link tool button (303-4): Used when setting a link that controls the distance between containers.

A ruler 308 is an index for indicating the position of a pointer, a page, a line, a margin guide and a container in the work area 306. A scroll bar 307 is an index for indicating where a container displayed in the work area 306 is located in a template 309 made up of a plurality of pages.

The palette 311 is a sub-window used when accessing an additional function such as a library for reading display data. The palette 311 includes a window control 312 used for moving, resizing and closing.

(2) Description of Work Area

Next, the work area 306 displayed in the window 301 will be described. The work area 306 is an area where each container placed in the template 309 is displayed or edited, or a document that has been created by inserting data into a container is displayed. The user can edit a template displayed in the work area 306 by performing layout-editing processing in Edit mode.

In View mode, the user can also confirm how a created template changes according to the amount or size of data by performing automatic layout-editing processing.

Note that the paper size of the template 309 displayed on the work area 306 can be set by the user. The actual number of pages in a document varies depending on the amount of data inserted. However, in case the amount of data inserted does not fit within a single page, an additional page is automatically created. The boundary line between pages in such a case is shown as a page margin 310 that indicates the outer edge of an area where a container can be placed for each page.

On the work area 306, the user places a container at a position where text data or image data is to be laid out, using the image container tool button 303-3 or the text container tool button 303-2.

Also, the user selects a placed container and gives an instruction, for example, to move that container or to change the size thereof, using the selection tool button 303-1. Further, the user sets a link between containers using the link tool button 303-4 (this will be described later in detail).

In the example shown in FIG. 3, a state is shown in which two containers 321 and 322 are placed on the template 309 made up of a single page and for which the paper size is set to an A4 format, and a link 412 has been set.

(3) Description of Containers

Next, containers placed in a template will be described in detail. A container refers to a space (also referred to as a “partial area”) in a template where fixed or variable text or image data is inserted from a database and that data is drawn.

A container can be moved, subject to size adjustment, or recreated by operating the mouse 133. The following is the definition of a container in the present embodiment.

1) Fixed or variable text or image data is inserted into a container. The variable text or image data is dynamic in that the data inserted into an identical container may vary from one document to another, that is, from one record to another. However, the variable text or image data in the present embodiment is not intended to include animated data or data that varies over time in a different manner.

On the other hand, the fixed text or image data is displayed in the same manner even in the case where it is inserted into any of the containers placed in different templates. However, in the case where a link is set between the fixed text or image data and the variable text or image data, the fixed text or image data may be laid out at different positions depending on the template, due to the influence of the variable text or image data.

2) A container is described as two types, namely a text container and an image container. Fixed or variable text data is inserted into a text container. Embedded image data or variable image data is inserted into an image container.

3) A constraint relating to a control as to how each piece of data is laid out during automatic layout processing (a control condition) can be set for a container. Examples of a control condition that can be set include such content as “the height of text or image data of a container is 4 inches at maximum”, and “the left edge of text or image data of a container is displayed at the same horizontal position in all documents”. By setting such constraints (including linking the fixed/variable text or image data with a container), the user can create many types of documents from a single template.

4) A container includes the same decorative function as text settings such as the background color, the border and the font style that are applied to text or image data. Such a setting is referred to as a “container attribute”. A container attribute can be set on a container-by-container basis.

5) By performing the automatic layout processing in View mode, data from the database 119 can be inserted into a container.

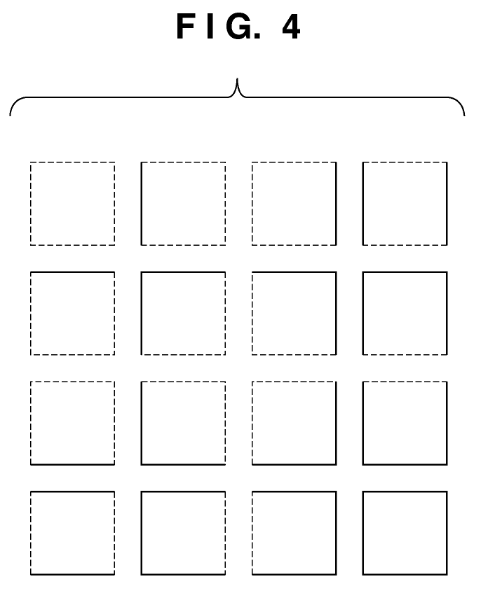

FIG. 4 shows the states of the sides of containers in accordance with the above-described control condition (16 different states for the sides). Note that, in general, the state of the sides (indicated by the dotted line or the solid line) of a container is an element that is displayed as an aid for designing a template, and therefore will not be drawn on an actual document. The setting values of the maximum and minimum values of the width and the height that are set as constraints for a container are displayed in the palette 311.

Note that in FIG. 4, the solid sides indicate fixed sides, and the dotted sides indicate variable sides.

(4) Link Setting Method

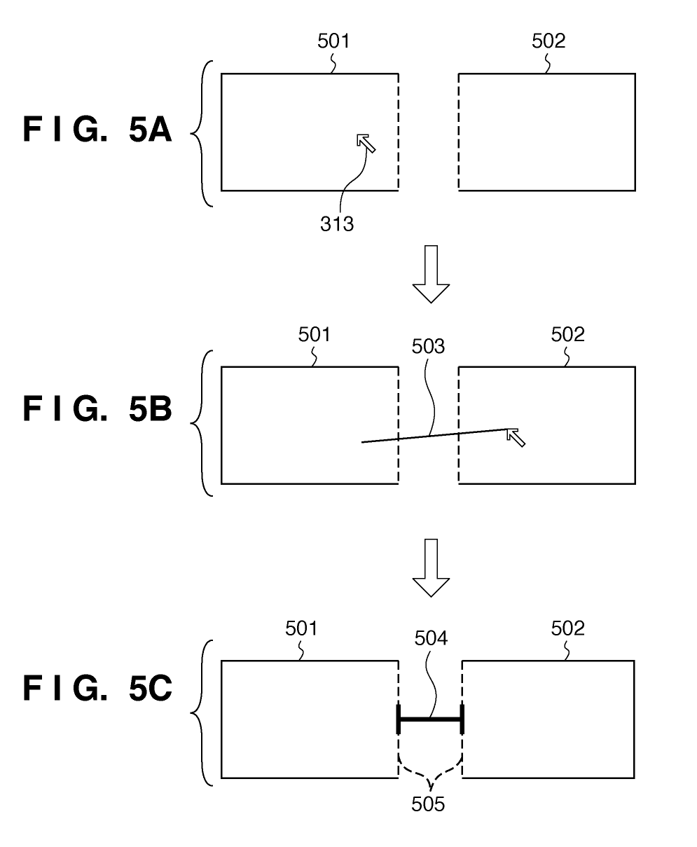

Next, a link setting method will be described with reference to FIGS. 5A to 5C. In order to set a link, containers (two at minimum) for setting the link are created first. In the example shown in FIGS. 5A to 5C, a case is described where a link is created using two containers.

Next, the link tool button 303-4 described above is put into the selected state. FIGS. 5A to 5C show an operation of setting a link from the state in which the containers have been created and the link tool button 303-4 is selected. In the following, FIGS. 5A to 5C will be described in sequence.

Numerals 501 and 502 in FIG. 5A denote fixed sides. Numeral 313 denotes a mouse pointer.

First, the user selects one of the containers for which a link is to be set by clicking on that container. Then, as shown in FIG. 5B, the user moves the mouse pointer to the other container, and clicks on that container. Numeral 503 in FIG. 5B denotes the line connecting the position that has been clicked on and the mouse pointer that has been moved in FIG. 5A, and indicates the position where a link will be set to the user. After completion of the second clicking in FIG. 5B, the link denoted by numeral 504 is displayed at the position that has been set, which brings the containers into a state shown in FIG. 5C.

Numeral 505 denotes sides indicated by dotted lines, and denotes variable sides, as described above. With such a design, the size of the left container 501 is variable to the right. On the other hand, the size of the right container 502 is variable to the left. Since the right and left containers are connected by a link, these containers operate such that their sizes are adjusted relative to each other while the distance therebetween is kept fixed.

3.2 Layout Engine

Next, a function realized by the layout engine 105 included in the layout editing application program 121 will be described.

(1) Flow of Automatic Layout Processing

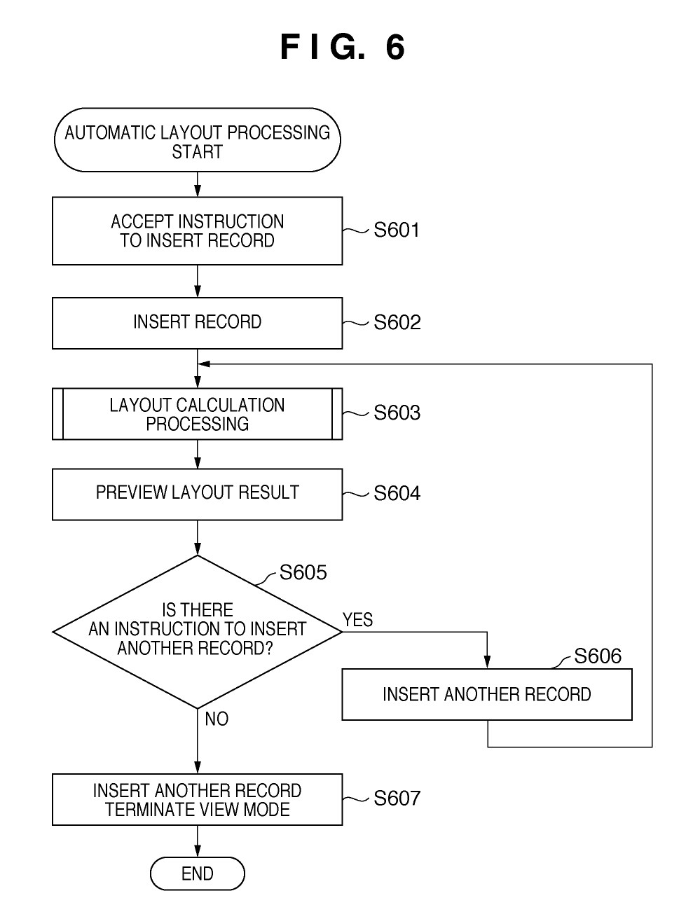

FIG. 6 is a flowchart illustrating the flow of automatic layout processing. When selection of View mode made by the user has been accepted and the mode has been shifted to View mode, automatic layout processing shown in FIG. 6 commences.

At step S601, an instruction to insert a record is accepted. At step S602, a record selected by the user (a data group that is to be inserted into a single template) is inserted. Upon completion of the record insertion, calculation for laying out the inserted record is performed at step S603. Note that the details of the layout calculation processing will be described later.

At step S604, the layout calculated at step S603 is displayed. At step S605, whether or not the user has given an instruction to insert another record is determined. If it is determined at step S605 that the user has given an instruction to insert another record, the procedure moves to step S606, where that record is inserted, and the procedure returns to S603.

On the other hand, if it is determined that the user has not given an instruction to insert another record, the procedure moves to step S607, where View mode is terminated.

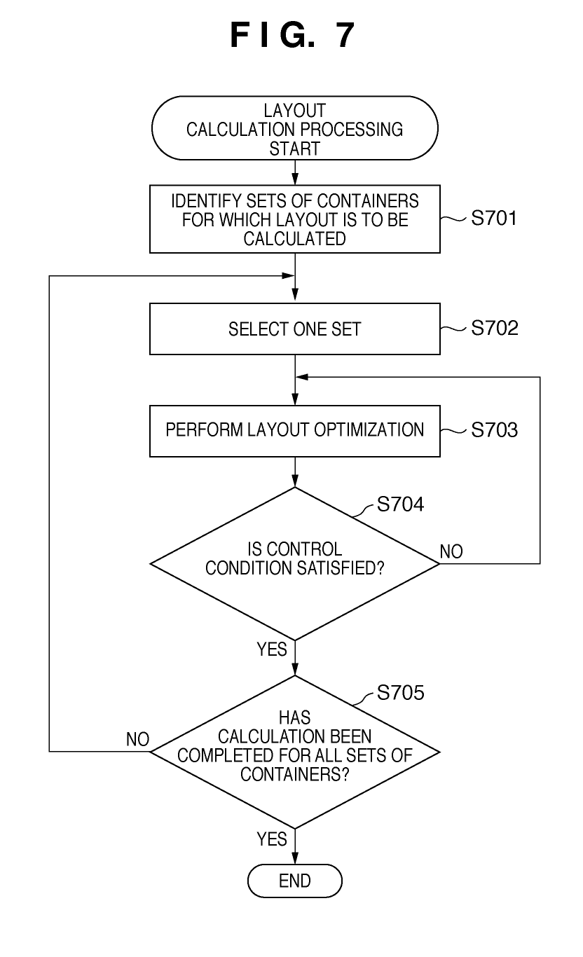

Next, the details of layout calculation processing (step S603) will be described. FIG. 7 is a flowchart illustrating the details of layout calculation processing (step S603).

At step S701, sets of containers that are associated with each other are identified in order to perform a layout calculation. In the layout calculation processing, calculation is performed taking containers that are associated with each other by a link as a single set.

At step S702, in order to perform layout calculation, a single set of containers is selected from the sets of containers identified at step S701.

At step S703, layout calculation is performed on the selected single set of containers. Specifically, layout optimization is performed such that the difference between the size of the containers that are laid out and the size of the actual data is minimized. The layout optimization is performed in such a manner that the difference between the size of data inserted into each container and the size resulting from such laying out is as close as possible among the containers that are associated so that their sizes dynamically change.

At step S704, whether or not the layout that has been optimized at step S703 violates the control condition is determined. If it is determined at step S704 that the layout violates the control condition, the procedure returns to step S703, where layout calculation is performed again so as not to violate the control condition.

As described above, a control condition is a constraint set by the user during layout-editing processing, and includes definitions relating to the size and the position of a container, the state of a side, and the length of a link. If it is determined at step S704 that layout calculation has been performed so as not to violate the control condition, it is determined that the layout of that set of containers is completed, and the procedure moves to step S705.

At step S705, whether or not layout calculation has been performed for all of the sets of containers is determined. If it is determined at step S705 that there is any set of containers for which layout calculation has not been performed, the procedure returns to step S702.

On the other hand, if it is determined at step S705 that layout calculation has been performed for all of the sets of containers, the procedure ends.

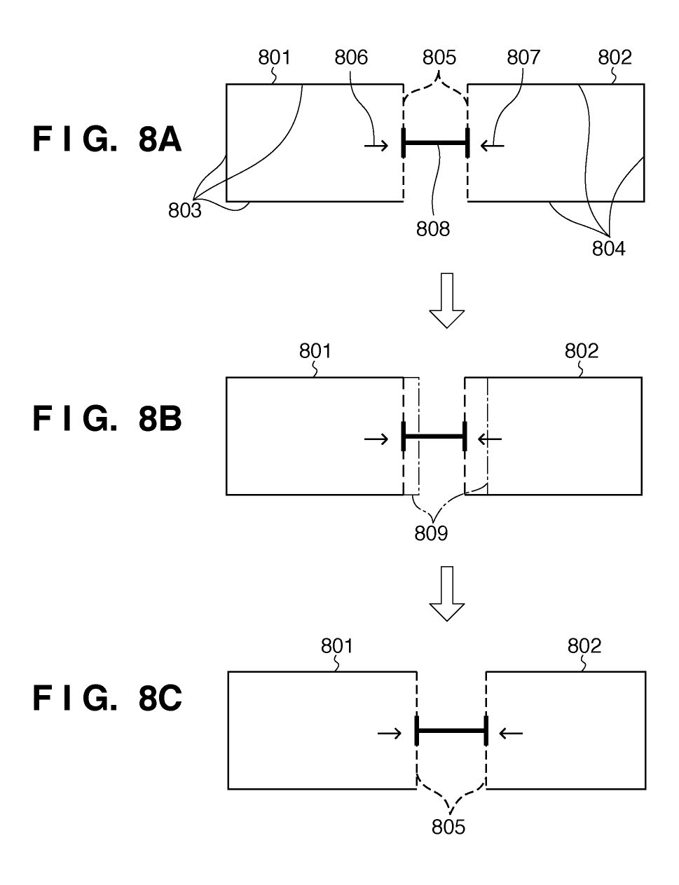

FIGS. 8A to 8C are diagrams showing an example of the operation of containers located on the work area 306 when layout calculation processing has been performed.

FIG. 8A shows a state in which a predetermined record has been inserted, and layout calculation has been performed. Numerals 801 to 804 denote fixed sides, numeral 805 denotes variable sides, numerals 806 and 807 denote arrows indicating the directions of change for the variable sides, and numeral 808 denotes a link.

Here, it is assumed that the record is changed and data pieces with different sizes are inserted in this state. FIG. 8B shows how data pieces with different sizes have been inserted. Numeral 809 illustrates the sizes of data pieces inserted into the containers.

As a result of performing layout calculation on the data pieces of different sizes that have been inserted, the containers are as shown in FIG. 8C. The layout calculation is performed such that the sizes of the containers after layout calculation differ in a similar degree from the sizes of the corresponding data pieces that are actually inserted, and that the above-described control condition will not be violated. Accordingly, in FIG. 8C, the sizes (809) of the two data pieces shown in FIG. 8B and the sizes (805) of the corresponding data pieces after calculation show a similar degree of difference.

(2) Automatic Layout Processing for Multiple Records

Next, an outline of automatic layout processing for multiple records will be described as a function realized by the layout engine 105.

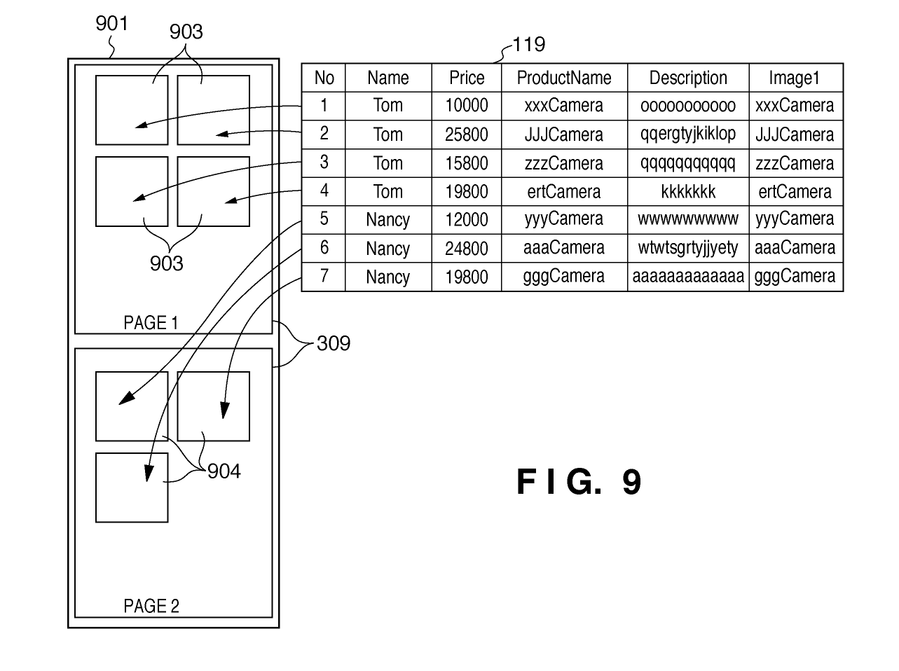

FIG. 9 shows an outline of automatic layout processing for multiple records. Numeral 901 denotes a document, numeral 309 denotes a template, and numeral 119 denotes a database.

Records Nos. 1 to 7 are stored in the database 119. In the case of an automatic layout system in which one record is present for one document, 7 documents are created.

On the other hand, in the case of an automatic layout system 100 that supports multiple records in which multiple records are present for one document, the automatic layout processing is performed in the following manner.

First, a column specifying the multiple records is arbitrarily specified by the user via the user interface 103. In this example, it is assumed that the field name, Name has been specified. Then, the layout engine 105 recognizes records having the same field name as the specified field name as records that are laid out in the same template within one document.

In the example shown in FIG. 9, records Nos. 1 to 4 have the Name “Tom”, and therefore will be inserted into the same template. Records Nos. 5 to 7 have the Name “Nancy”, and therefore will be inserted into a template different from the template for the records having the Name “Tom”.

4. Description of Template in the Present Embodiment

The following describes a template that can be created by the layout editing application program 121 according to the present embodiment performing layout-editing processing.

As described above, the page margin 310 is usually indicated in a template created on the work area 306, and the maximum area where containers can be placed for each page is indicated.

With the layout editing application program 121 according to the present embodiment, it is possible to create a template on which a container whose fixed sides correspond to a boundary line indicated by the page margin 310.

Note that a container whose fixed sides correspond to a boundary line indicated by the page margin 310 is hereinafter referred to as a “page container”.

With the layout editing application program 121 according to the present embodiment, it is also possible to set a link between a page container and an ordinary container.

A link that is set between an ordinary container and a page container is hereinafter referred to as a “page link”. Note that a page link can be set by the same procedure as with a link between ordinary containers.

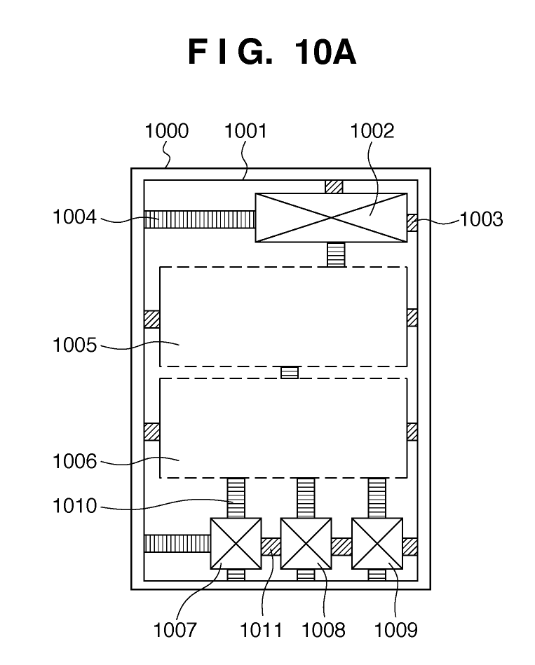

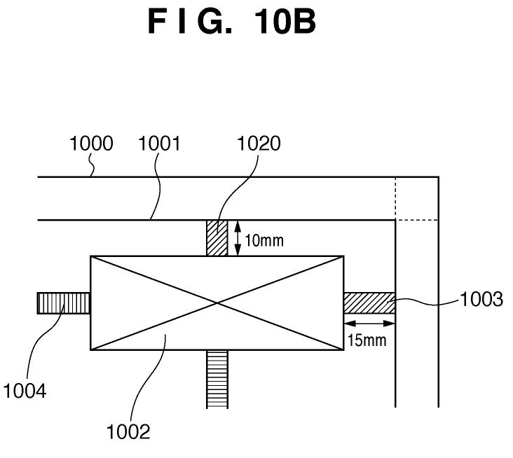

FIG. 10A is a diagram showing an example of a template that includes a page container and page links, and FIG. 10B is an enlarged view of the upper right portion of FIG. 10A. A template that includes a page container and page links will be described with reference to FIGS. 10A and 10B.

Numeral 1000 denotes a template for which a paper size has been set by the user. In this example, it is assumed that the paper size of an A4 format has been set.

Numeral 1001 denotes a page container. The page container 1001 is a type of fixed container having a defined region obtained by subtracting the margin from the paper size (an area where ordinary containers can be placed), and it is differentiated from ordinary containers. Note that the position and the size of the page container 1001 are determined by the paper size and the margin. Therefore, the user does not need to intentionally place a page container when creating a template (i.e., the user only needs to set the paper size and the margin).

Numerals 1002, 1007, 1008 and 1009 denote image containers into which image data is inserted, and numerals 1005 and 1006 denote text containers into which text data is inserted.

Numerals 1003 and 1004 denote page links that link the page container and the containers. The page links are classified into two types, namely, a fixed page link 1003 by which the distance between the page container and the containers is fixed, and a variable page link 1004 by which the above-mentioned distance is varied.

Numeral 1010 denotes variable links that link containers with each other, and numeral 1011 denotes fixed links that link containers with each other.

Note that during automatic layout processing, the page container and the page links included in the template 1000 operate in the same manner as ordinary links and containers. Specifically, as shown in FIG. 10B, with the fixed page link 1003 and the page container 1001, the container 1002 is fixed at a distance of 15 mm from the right edge of the page container 1001 when data is inserted. Also, with the fixed page link 1020 and the page container 1001, the container 1002 is fixed at a distance of 10 mm from the upper edge of the page container 1001 when data is inserted.

5. Description of Processing Performed When Changing Paper Size of Template

The following describes processing performed when a paper size that has been set for the created template 1000 is changed during layout-editing processing.

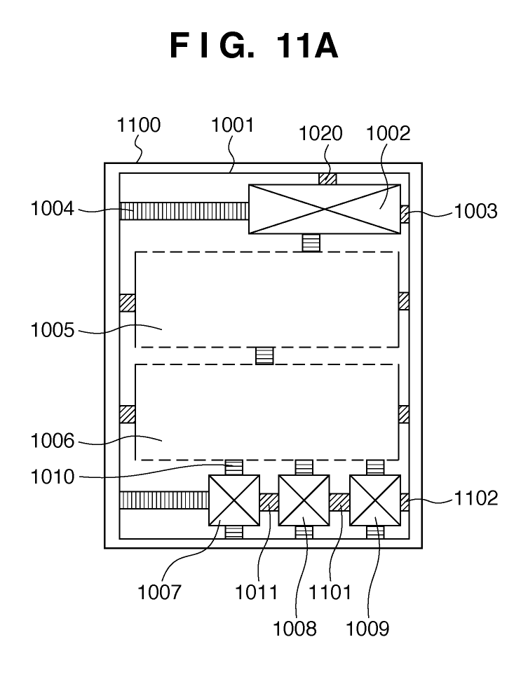

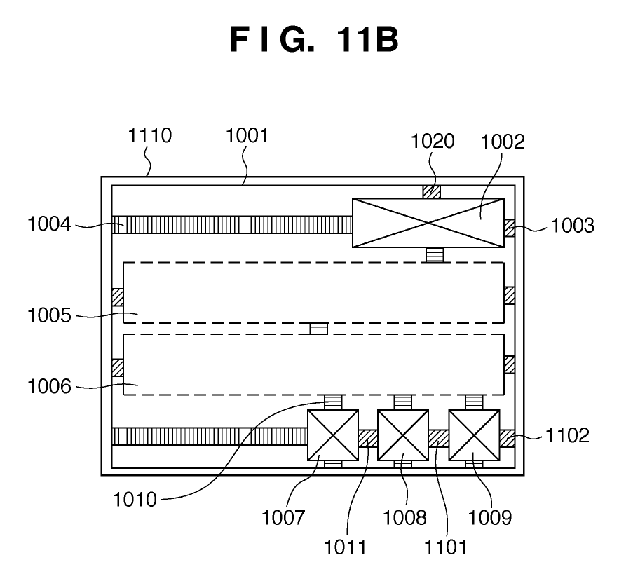

FIGS. 11A and 11B are diagrams showing examples of a template after changing the paper size set for the template 1000 shown in FIG. 10A in the middle of layout-editing processing in Edit mode and relocating the containers following such change.

Of these drawings, FIG. 11A shows a template after changing the paper size set for the template 1000 from A4 format to US Letter format and relocating the containers. FIG. 11B shows a template after changing the paper size set for the template 1000 from Portrait A4 format to Landscape A4 format and relocating the containers.

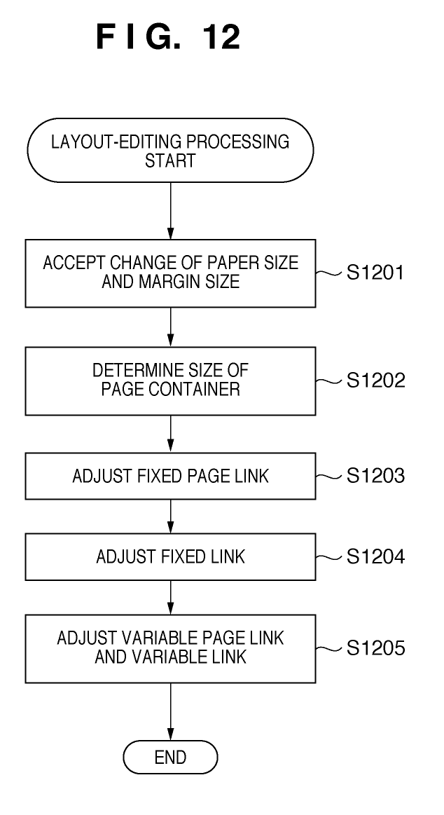

FIG. 12 is a flowchart illustrating the flow of processing in the case where the paper size set for a template is changed in the middle of layout-editing processing in Edit mode and containers in that template are relocated. The flowchart of FIG. 12 will be described with reference to FIGS. 11A and 11B.

At step S1201, the layout editing application program 121 accepts a change in the settings of the paper size and the margin size in Edit mode. Here, it is assumed that the paper size is changed to US Letter format or Landscape A4 format.

At step S1202, the layout editing application program 121 determines the size of the page container 1001 based on the changed paper and margin sizes. When the size of the page container 1001 has been determined, each of the containers is relocated within the frame of the page container 1001 in accordance with control conditions set for the page links, the links and the containers.

Although the operation of the page links is the same as the operation of ordinary links, the edges (boundary lines) of the page container are always handled as fixed edges, and the sides of the containers are always handled as variable sides. In the case where the page link is fixed, the positions of the sides of the containers are determined in accordance with the distance specified for the link. On the other hand, in the case where the page link is variable, the sides of the containers are placed such that the widths of the containers will not be changed.

Specifically, at step S1203, the layout editing application program 121 performs position adjustment based on fixed page links as position adjustment for each container. Subsequently, at step S1204, the layout editing application program 121 performs position adjustment based on fixed links.

In FIGS. 11A and 11B, since the fixed page link 1003 and the fixed page link 1020 are fixed page links, the container 1002 is relocated to the upper right of the page container 1001 with the distance between links 1003 and 1020 kept fixed.

Since the page links at the right and the left of the container 1005 and the container 1006 are fixed, the container 1005 and the container 1006 are relocated such that they are enlarged toward opposite sides in the page container 1001 to maintain the length of the right and left page links. Note that in the example of FIGS. 11A to 11B, a case is described where the containers are enlarged, but the containers may, of course, be reduced.

The container 1007, the container 1008 and the container 1009 are connected by the fixed links 1011 and 1101, and therefore operate as a single container during container relocation.

That is, the container 1009 is fixed at a predetermined distance from the right edge of the page container 1001 by the fixed page link 1102, and the container 1007 and the adjustment of the container 1008 follows the container 1009.

Next, at step S1205, position adjustment based on variable page links and variable links is performed. The variable page link 1004 is not associated with any other variable link. Accordingly, the horizontal width of the container 1002 will not be changed. A vertically placed variable link is subject to position adjustment in association with the upper and lower sides of the containers 1005 and 1006, as well as with another vertically placed variable link. The positions of the variable links and the variable sides of the containers are adjusted such that the containers can fit within the vertical width of the page container 1001. The position adjustment is performed in accordance with the ratios of each container and the settings of, for example, the maximum value and the minimum value.

6. Example in the Case Where Automatic Layout Processing Is Performed on a Template for Which the Paper Size Has Been Changed

The following describes an example in the case where automatic layout processing is performed on a template for which the paper size or the margin size has been changed during layout-editing processing.

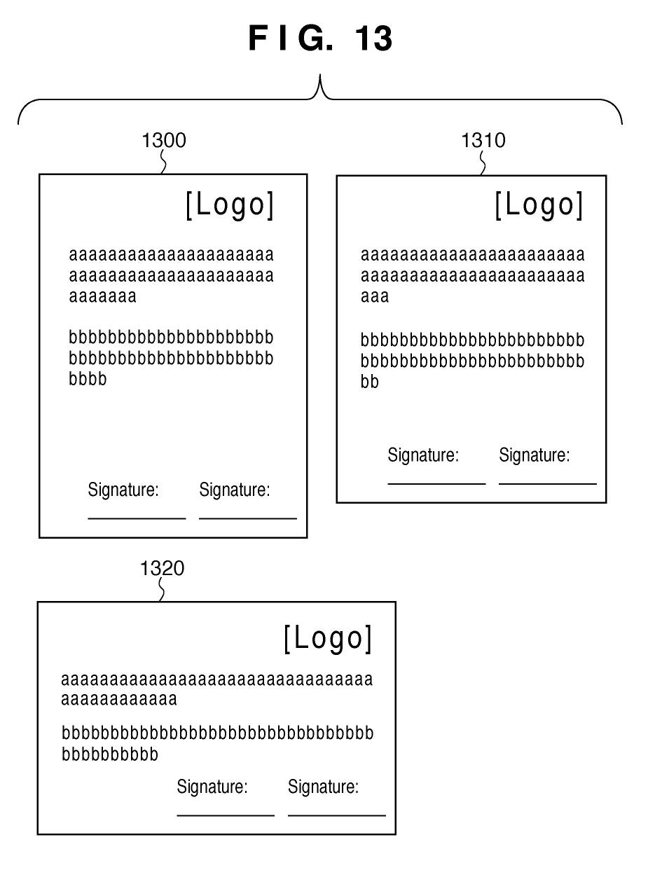

FIG. 13 is a diagram showing an example of a document created by performing automatic layout processing on a template for which the paper size or the margin size has been changed during layout editing. Numerals 1300, 1310 and 1320 denote documents after inserting data into the templates 1000, 1100 and 1110, respectively, and performing layout calculation.

In the example shown in FIG. 13, the size of the logo, seal impressions and text have not been changed. On the other hand, the format type of the text data has been changed and, hence, the form of the container has been changed, so that the locations of text wrapping differ from one format type to another.

As is clear from the above description, the layout editing application program according to the present embodiment adopts a configuration that can create a template including a page container and page links. Accordingly, even if a template for which a predetermined paper size has been set is later changed in the paper size and the margin size, it is possible to automatically change the size and the position of containers in conformity with the changed paper and margin sizes, and relocating the containers.

As a result, it is no longer necessary to create a template for each paper size unlike conventional templates for which the paper size is fixed, so that the workload on the user when using a layout editing application program can be reduced.

### Second Embodiment

The first embodiment has described the processing performed when the setting of the paper size is changed after creating a template based on a predetermined paper size in Edit mode. However, the present invention is not limited thereto, and the setting of the paper size can be changed after inserting data into a created template in View mode.

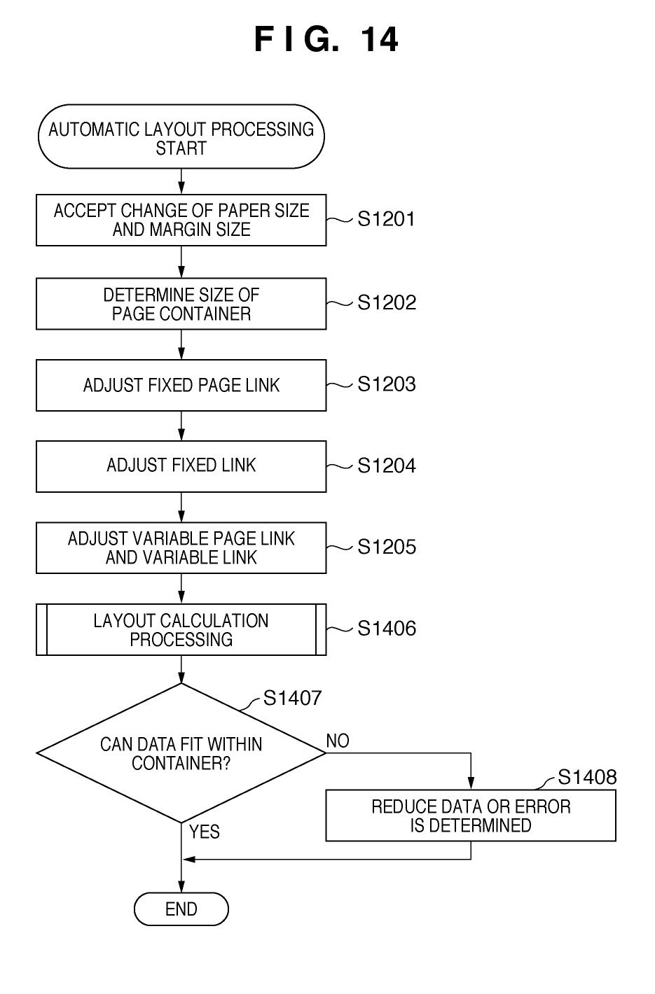

FIG. 14 shows a flowchart illustrating the flow of processing when the paper size set for a template is changed after performing automatic layout processing and inserting data in View mode.

Note that the processing from steps S1201 to S1205 is the same as the processing from steps S1201 to S1205 in FIG. 12, and the description thereof therefore has been omitted.

Upon completion of the processing of relocating containers at steps S1201 to S1205, the procedure automatically moves to step S1406. At step S1406, layout calculation processing is performed on data that has already been inserted into the relocated containers. Note that the layout calculation processing performed at step S1406 has already been described with reference to FIG. 7, and the description thereof has been therefore omitted here.

Upon completion of the layout calculation at step S1406, whether or not the data can fit within the template is determined at step S1407. The data inserted is dynamic data, and therefore may not fit in a predetermined container.

If it is determined at step S1407 that the data can fit without any problem, the procedure ends. On the other hand, if it is determined that the data cannot fit, the procedure moves to step S1408, where the data is reduced, or an error is determined.

One conceivable method for reducing data where the data is text data is a method that involves reducing the font size. Where the data is image data, a method that involves reducing the data while maintaining the aspect ratio, and a method that involves reducing the data in conformity with the container size are also conceivable.

If an error is determined, an error message dialog may be displayed, or a log may be recorded.

Although the relocation of the containers following a change in the paper size and the margin size and the layout calculation processing are performed separately in the flowchart shown in FIG. 14, they may be performed simultaneously.

As is clear from the foregoing descriptions, the present embodiment enables the settings of the paper size and the margin size to be changed even after performing automatic layout processing.

### Third Embodiment

In the first and second embodiments, when changing the settings of the paper size and the margin size, containers are relocated so as to match the changed paper size and the like. However, the present invention is not limited thereto, and it is possible to adopt a configuration in which enlargement or reduction processing is performed after relocating containers using a template having a format type that is changed and having a size similar to the original format type.

For example, in the case of changing the US Letter format to the A3 or A5 format, enlargement or reduction to A3 or A5 format may be performed after temporarily relocating containers on a template with a paper size of an A4 format.

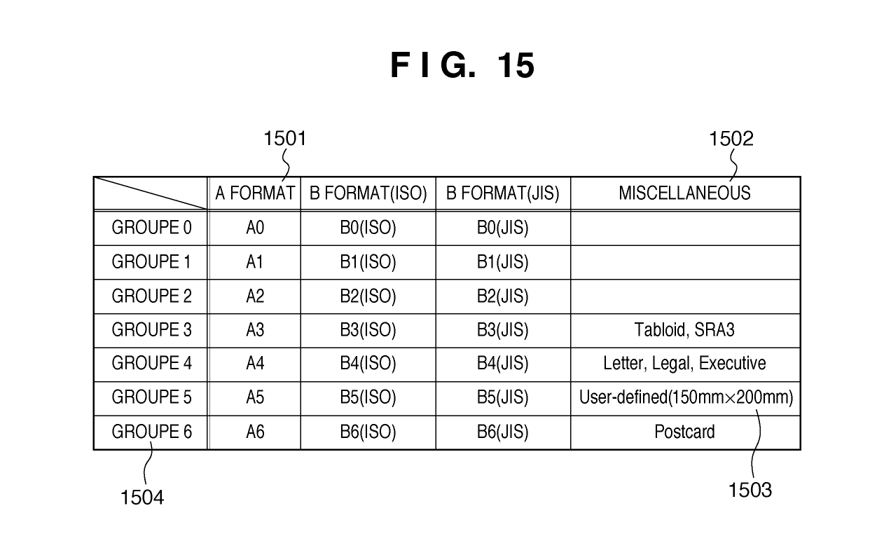

Note that at this time, the selection of a size similar to the original format type is performed in accordance with a group setting relating to the format type and the size of paper as in the example shown in FIG. 15.

In FIG. 15, numeral 1501 denotes a format A, which is divided into groups A0 to A6. Numeral 1502 denotes a miscellaneous column in which paper sizes having no format family are divided into groups.

Note that a plurality of paper sizes can be set as a group in the miscellaneous column 1502. In addition, a paper size defined by the user can be set as a group, as indicated by numeral 1503. Numeral 1504 denotes a group line, and the user can also add and delete groups.

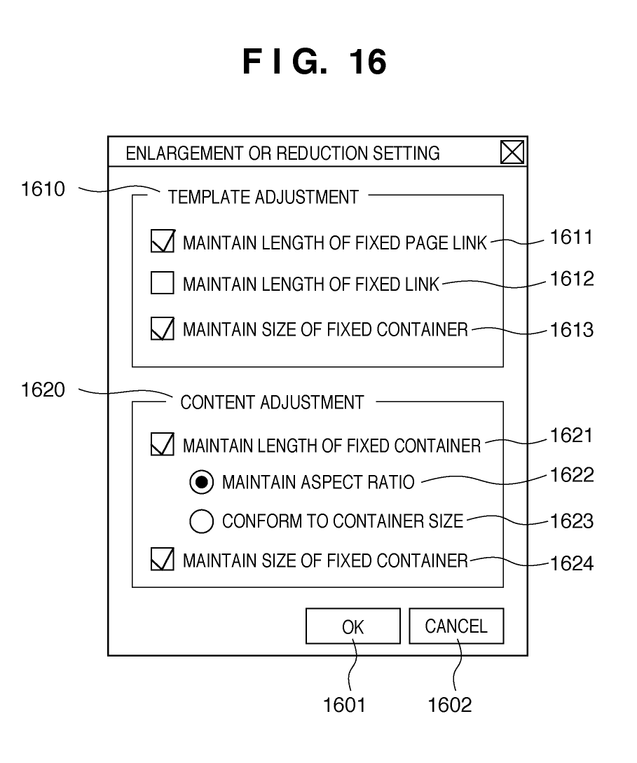

FIG. 16 is a diagram showing an example of a settings dialog for inputting settings relating to enlargement or reduction processing. The settings dialog is displayed when an instruction to change the settings of the paper size is provided. Numeral 1610 denotes a settings group relating to the relocation of containers on a template, and numeral 1620 denotes a settings group relating to the adjustment of data that is inserted.

Basically, the enlargement or reduction processing performed after relocating containers is performed on containers in accordance with the enlargement ratio or reduction ratio of the paper size, while maintaining the aspect ratio. However, it is possible to provide a setting such that enlargement or reduction is not performed for a fixed container or link.

Numeral 1611 denotes a check box for setting whether or not the length of a fixed page link is maintained. Numeral 1612 denotes a check box for setting whether or not the length of a fixed link is maintained. Numeral 1613 denotes a check box for setting whether or not the size of a fixed container is maintained. Any checked item will be ignored during enlargement or reduction.

Note that if any of the items shown in the settings group 1610 is checked, this indicates that a container that is not to be subjected to enlargement or reduction and a container that is to be subjected to enlargement or reduction are present together, and the container layout on a template will therefore be deformed. In that case, the same processing as that shown at step S1204 is performed after enlargement or reduction. Thus, containers in a template are relocated again.

Among the items shown in the settings group 1620, numeral 1621 denotes a check box for setting whether or not image data is subjected to enlargement or reduction. If the check box 1621 is checked, it is also possible to select, using radio buttons, whether to perform enlargement or reduction while maintaining the aspect ratio in a container (1622), or to perform enlargement or reduction in conformity with the container size (1623). Numeral 1624 denotes a check box for setting whether to increase or decrease the font size of text data.

Numeral 1601 denotes an OK button, and the settings of a dialog are finalized by depressing the OK button 1601. Numeral 1602 is a Cancel button, and the settings of a dialog are cancelled by depressing the Cancel button 1602.

Note that such setting is performed for the entire template in the settings shown in FIG. 16, but it is possible to adopt a configuration in which such setting is performed on a container-by-container or link-by-link basis.

As is clear from the foregoing descriptions, the present embodiment adopts a configuration in which, when the paper size or the margin size has been changed, containers are temporarily relocated on a template having a format type that is changed and having a size similar to the original format type, and then enlargement or reduction is performed. Consequently, it is possible to realize a more suitable layout.

### Fourth Embodiment

In the first embodiment, a page link is manually set or cancelled by the user in Edit mode. However, the present invention is not limited thereto, and it is also possible to adopt a configuration in which a page link is automatically set or cancelled during layout-editing processing.

1. Automatic Link Processing

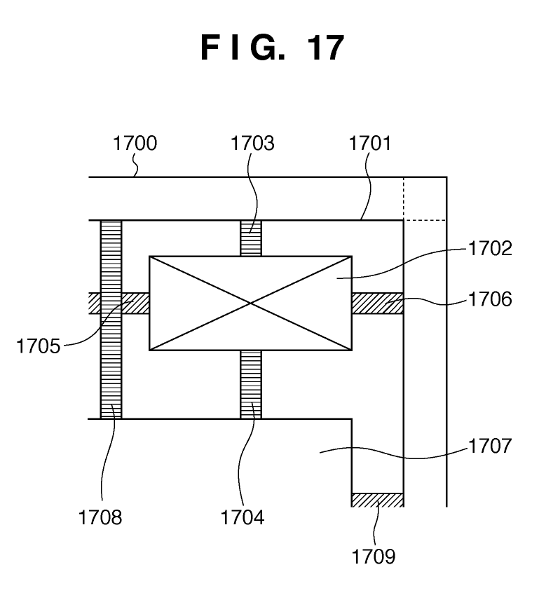

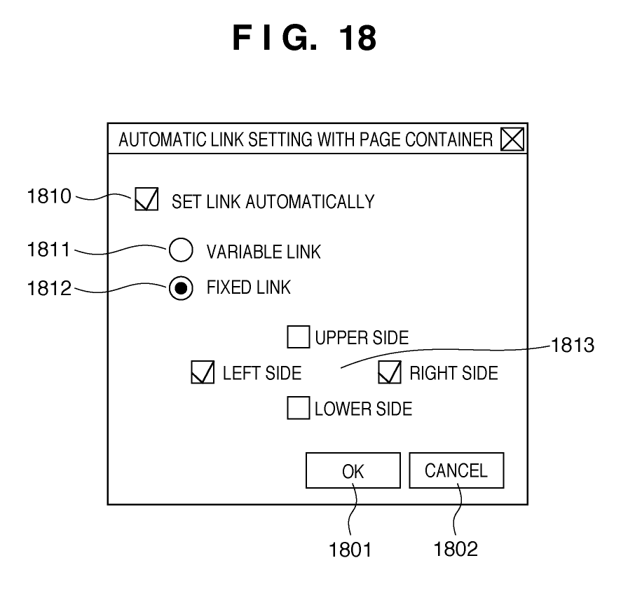

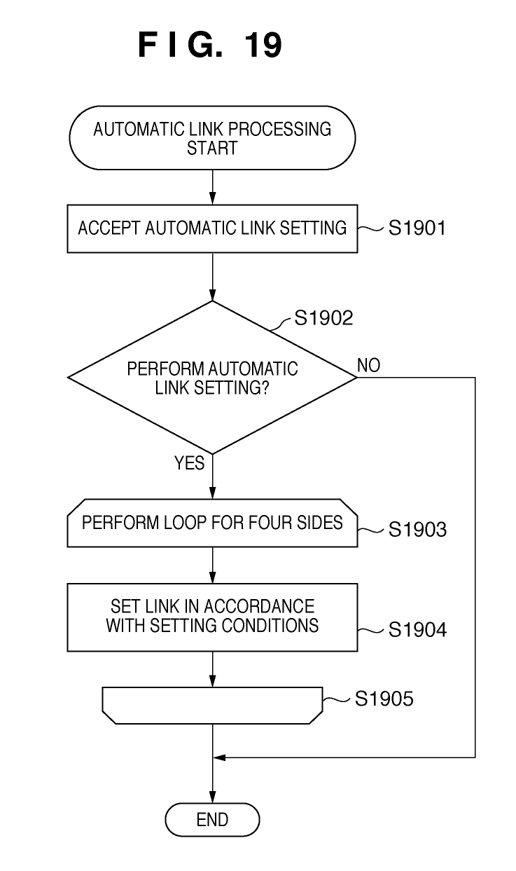

The following describes processing for automatically setting a page link between a page container and a container in the layout-editing processing in Edit mode (automatic Link processing) with reference to FIGS. 17, 18 and 19. FIG. 17 is a diagram showing a template on which automatic link processing has been performed in layout-editing processing. FIG. 18 is a diagram showing an example of a settings dialog for automatic link processing. FIG. 19 is a flowchart illustrating the flow of automatic link processing.

In FIG. 17, a page container 1701 is determined based on the paper size and the margin size. When the user places a container 1702 in this state, a page link is automatically set between each of the four sides of the container 1702 and the page container 1701.

At step S1901, a setting item relating to automatic link processing is referred to, and that setting item is acquired. One example of the setting items relating to automatic link processing is as shown in FIG. 18.

In FIG. 18, numeral 1810 denotes a check box for setting whether or not to perform automatic link processing. If the check box 1810 is checked, automatic link processing is performed, and if it is not checked, automatic link processing is not performed, so that a page link is manually set.

At step S1902, whether or not to perform automatic link processing is determined, and if it is determined that automatic link processing is performed, the procedure moves to step S1903. On the other hand, if it is determined that automatic link processing is not performed, the automatic linking the procedure ends.

Note that whether the automatically set page link is fixed or variable depends on which of the radio buttons 1811 and 1812 is selected.

Numeral 1811 denotes a radio button for specifying a variable page link. If the radio button 1811 is specified, a variable page link is automatically set for the four sides of a placed container. Numeral 1812 denotes a radio button for specifying a fixed page link. If the radio button 1812 is specified, a fixed page link is automatically set for any side that is checked in a check box 1813.

For those sides that are not checked in the check box 1813, a variable page link is automatically set. The settings of the dialog are finalized by depressing the OK button 1801. The settings of the dialog are cancelled by depressing the Cancel button 1802.

FIG. 17 shows a template in the case where automatic link processing has been performed based on the settings dialog shown in FIG. 18. Specifically, the drawing shows the case where automatic link processing is performed in a state in which the check box 1810 for setting whether to perform automatic link processing is checked, the fixed link radio button 1812 is specified, and the left and right sides are checked in the check box 1813.

When the container 1702 is placed on the page, a variable page link 1703 is automatically set between the upper side and an edge opposing thereto. Also, a variable page link 1704 is automatically set between the lower side and an edge opposing thereto. Furthermore, a fixed page link 1705 is automatically set between the left side and an edge opposing thereto, and a fixed page link 1706 is automatically set between the right side and an edge opposing thereto (steps S1903 to S1905).

The same operation is performed also in the case where the container 1707 is placed on the page. A variable page link 1708 is automatically set between the upper side and an edge opposing thereto, and a fixed page link 1709 is automatically set between the right side and an edge opposing thereto.

Note that the present embodiment is configured such that an ON/OFF setting can be set for the display of a page link on the window 301.

2. Page Link Automatic Deletion Processing

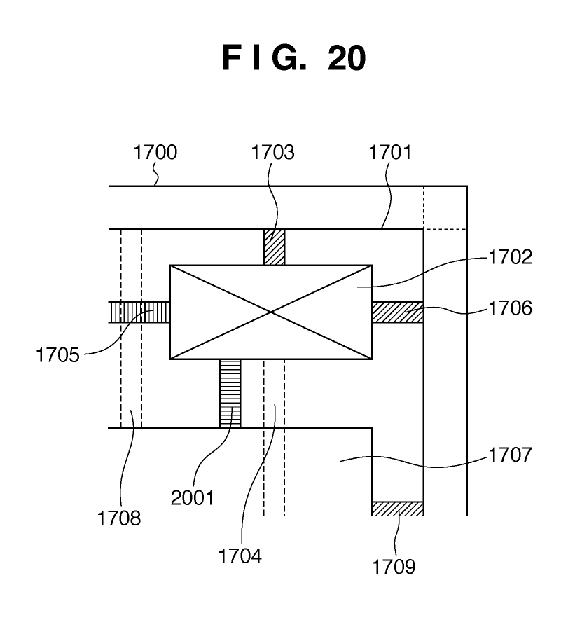

Page link automatic deletion processing will be described below with reference to FIG. 20. In the case where a link is set between containers during layout-editing processing in Edit mode, any page link between a container and a page container is automatically deleted.

In FIG. 20, in the case where the user sets a variable link 2001 between the lower side of the container 1702 and the upper side of the container 1707, the page link 1704 and the page link 1708 are automatically deleted. Note that the present embodiment is configured such that, when the user deletes the variable link 2001 that has been set once, the page link 1704 and the page link 1708 are automatically set again based on the settings shown in FIG. 18.

As is clear from the foregoing descriptions, the present embodiment is configured such that a page link is automatically set or deleted. Consequently, it is possible to reduce the workload on the user during layout-editing processing in Edit mode.

### Other Embodiments

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-284731 filed on Nov. 5, 2008, which is hereby incorporated by reference herein in its entirety.

What is claimed is:

1. An information processing apparatus that creates a link associating partial areas placed on a template, and performs layout processing corresponding to a created link in response to input of data into the partial areas, the apparatus comprising:
a determination unit configured to determine, based on a paper size set for the template, an area where the partial areas can be placed in the template for each page constituting the template;
a creation unit configured to create a link associating a boundary line defining an outer edge of the area with the partial areas; and
a relocation unit configured to change, in the case where the paper size set for the template has been changed and the area has been changed, a position and a size of the partial areas corresponding to the link created by the creation unit.

2. The information processing apparatus according to claim 1,
wherein layout processing corresponding to a link associating the partial areas to each other, and a link associating the boundary line and the partial areas is performed in response to input of the data into the partial areas.

3. The information processing apparatus according to claim 1,
wherein the creation unit is configured to automatically create, each time a partial area is newly placed on the template, a link that associates each side of the newly placed partial area with the boundary line located at a position opposing said side.

4. The information processing apparatus according to claim 3,
wherein the creation unit is configured to automatically delete the automatically created link in the case where a side that has been associated by the automatically created link is newly associated with a side of another partial area.

5. The information processing apparatus according to claim 1,
wherein, in a case where relocating the partial areas by the relocation unit causes the partial areas to overlap each other, the size of the partial areas is reduced.

6. An information processing method performed in an information processing apparatus that creates a link associating partial areas placed on a template, and performs layout processing corresponding to a created link in response to input of data into the partial areas, the method comprising:
a determination step of determining, based on a paper size set for the template, an area where the partial areas can be placed in the template for each page constituting the template;
a creation step of creating a link associating a boundary line defining an outer edge of the area with the partial areas; and
a relocation step of changing, in the case where the paper size set for the template has been changed and the area has been changed, a position and a size of the partial areas corresponding to the link created by the creation unit.

7. A computer-readable storage medium in which a program for causing a computer to execute the information processing method according to claim 6 is stored.
